(19) United States
(12) Patent Application Publication
(10) Pub. No.: US 2020/0111355 A1
(43) Pub. Date: Apr. 9, 2020

(54) SYSTEM AND METHOD FOR ERRACTIC DRIVER ALERT

(71) Applicant: Continental Automotive Systems, Inc., Auburn Hills, MI (US)

(72) Inventors: Javier Alcazar, Royal Oak, MI (US); Ganesh Adireddy, Bloomfield Hills, MI (US); Dominik Froehlich, Royal Oak, MI (US); Ibro Muharemovic, Warren, MI (US)

(73) Assignee: Continental Automotive Systems, Inc., Auburn Hills, MI (US)

(21) Appl. No.: 16/294,979

(22) Filed: Mar. 7, 2019

Related U.S. Application Data
(60) Provisional application No. 62/741,207, filed on Oct. 4, 2018.

(51) Int. Cl. G08G 1/0965

(52) U.S. Cl. CPC G08G 1/0965

(57) ABSTRACT

A notification or warning system which alerts various drivers and pedestrians of a vehicle which is being driven erratically. A vehicle is capable of running a self-diagnosis on various vehicle dynamics data to determine if erratic driving is present, and the vehicle is also able to communicate (via Dedicated Short Range Communication (DSRC), WiFi, table devices, etc.) to alert other traffic participants (i.e., drivers of other vehicles or pedestrians) of such a situation. A plurality of detection devices detect when the vehicle is performing at least one undesirable driving maneuver, and transfer information regarding the undesirable driving maneuver to a first communication device. The first communication device transmits a signal to a second communication device such that the second communication device commands a notification device to generate a warning indicating that the vehicle is performing the undesirable autonomous driving maneuver.

### CROSS-REFERENCE TO RELATED APPLICATIONS

This application claims the benefit of Provisional Application 62/741,207, filed Oct. 4, 2018. The disclosure of the above application is incorporated herein by reference.

### FIELD OF THE INVENTION

The invention relates generally to an erratic driver notification system which has the capability to alert traffic participants about the presence and location of a vehicle that is being driven erratically, such as when the vehicle is performing at least one undesirable driving manevuer.

### BACKGROUND OF THE INVENTION

Vehicles driving erratically or unsafely present dangers to both other vehicles and nearby pedestrians. Intersections and cross-walks for pedestrians present one of the most dangerous areas where accidents may occur, such as an automobile hitting a pedestrian. Additionally, pedestrians are also distracted by cell phones, tablet computers, billboards, other pedestrians, and the like, which may limit the ability of the pedestrian to be fully aware of any dangers resulting from vehicles that may be driving unsafely.

Furthermore, a vehicle being driven erratically presents a danger on highways, residential roads, or other types of roads where other vehicles are present. However, there are times when a nearby vehicle or pedestrian may not be aware of a vehicle driving erratically. This may be the result of the pedestrians and drivers of the surrounding vehicles being unable to see the vehicle being driven erratically because of the location of the erratically driven vehicle, or obstructions such buildings other vehicles blocking the view of the vehicle being driven erratically.

Accordingly, there exists a need for a notification or warning system which is able to notify drivers of various vehicles and pedestrians when there is a dangerous situation resulting from a vehicle being driven erratically and performing one or more unsafe driving maneuvers.

### SUMMARY OF THE INVENTION

The present invention is a notification or warning system which alerts various drivers and pedestrians of a vehicle which is being driven erratically. In one embodiment, a vehicle is capable of running a self-diagnosis on various vehicle dynamics data to determine if erratic driving is present, and the vehicle is also able to communicate (via Dedicated Short Range Communication (DSRC), WiFi, table devices, etc.) to alert other traffic participants (i.e., drivers of other vehicles or pedestrians) of such a situation.

Vehicle dynamics data used includes, but it is not limited to, longitudinal velocity, longitudinal acceleration, lateral acceleration, yaw rate, etc. Examples of erratic driving include, but are not limited to, a vehicle whose motion is inconsistent, changeable, irregular, turbulent, or unsettled when compared to the expected traffic flow.

In one embodiment, the present invention is an erratic driver notification system having a plurality of detection devices being part of a vehicle and for detecting the position of the vehicle, and a control unit being part of the vehicle, the control unit in electrical communication with the plurality of detection devices. The notification system also includes a first communication device being part of the vehicle, the first communication device in electrical communication with the control unit, a second communication device in wireless communication with the first communication device, and a notification device in electrical communication with the second communication device.

The plurality of detection devices detect when the vehicle is performing at least one undesirable driving maneuver, and transfer information regarding the at least one undesirable driving maneuver to the first communication device. The first communication device transmits a signal to the second communication device such that the second communication device commands the notification device to generate a warning indicating that the vehicle is performing the at least one undesirable autonomous driving maneuver.

In one embodiment, the second communication device and the notification device are part of a nearby vehicle, and the second communication device commands the notification device to alert the driver of the nearby vehicle that the vehicle is performing the undesirable driving maneuver. Additionally, there may be situations where there are several vehicles which are capable of communicating with the first communication device in a similar manner, such that the drivers of the others vehicles may be made aware of the vehicle performing the undesirable driving maneuver and may take necessary steps to avoid danger.

In another embodiment, the second communication device and the notification device are part of a personal device, such as a mobile phone, and at least one vulnerable road user is in possession of the mobile phone. The first communication device transfers information regarding the undesirable driving maneuver to the mobile phone, and the notification device alerts the vulnerable road user that the vehicle is performing the at least one undesirable driving maneuver. This communication may also take place between the first communication device and other cell phones in a similar manner, such that many vulnerable road users may be made aware of the vehicle performing the undesirable driving maneuver.

The position of the vehicle includes at least one coordinate, and may have several coordinates, and the coordinates are detected by at least one of the detection devices. The coordinates include, but are not limited to, pitch angle, roll angle, yaw angle, yaw displacement, and yaw rate. The coordinates may also include lateral direction, longitudinal direction, and vertical direction.

The plurality of detection devices are also operable for detecting the speed of the vehicle, acceleration of the vehicle, wheel speed of the vehicle, and front wheel angle of the vehicle.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a perspective view of a vehicle traveling on a road and surrounded by other vehicles, where the vehicle has an erratic driver notification system, according to embodiments of the present invention;

FIG. 2 is a diagram of an erratic driver notification system, according to embodiments of the present invention;

FIG. 3 is a perspective view of a vehicle having an erratic driver notification system, according to embodiments of the present invention;

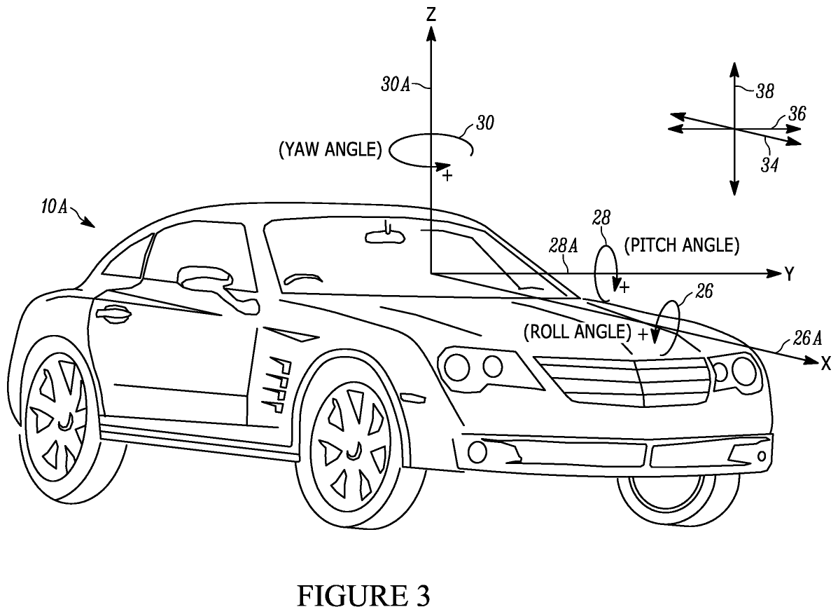

FIG. 4 is a perspective view of a vehicle traveling on a road and surrounded by other vehicles, where the vehicle has an erratic driver notification system, according to embodiments of the present invention.

### DETAILED DESCRIPTION OF THE PREFERRED EMBODIMENTS

The following description of the preferred embodiment(s) is merely exemplary in nature and is in no way intended to limit the invention, its application, or uses.

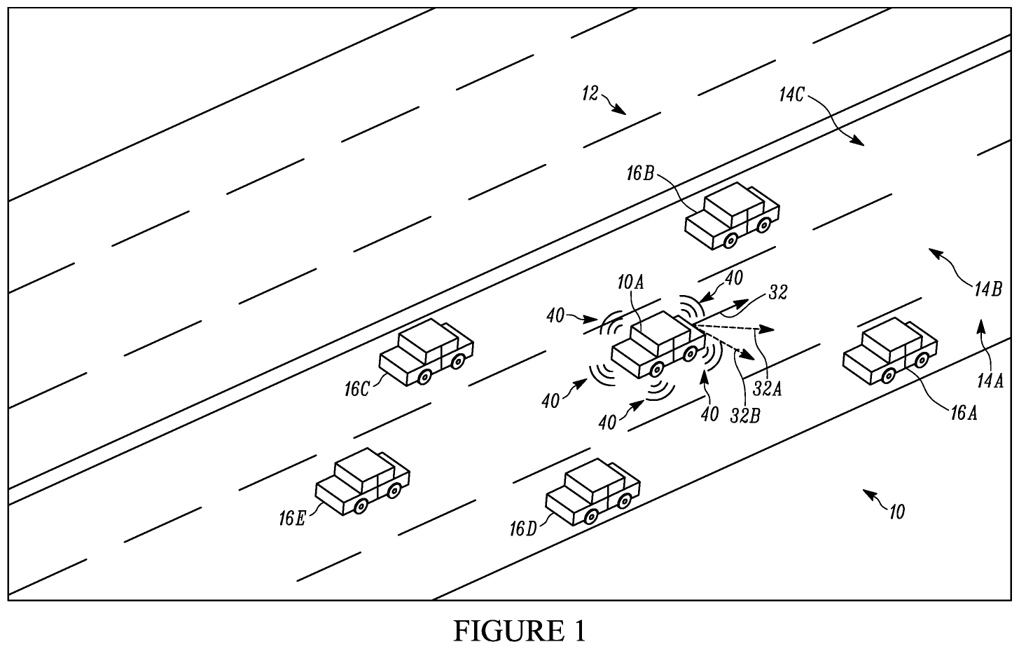

A first example of a vehicle having an erratic driver notification system is shown in FIG. 1, generally at 10. The vehicle 10A is travelling on a road, shown generally at 12, having several lanes 14A,14B,14C, and there are other vehicles 16A,16B,16C,16D,16E traveling on the road 12 in proximity to the vehicle 10A.

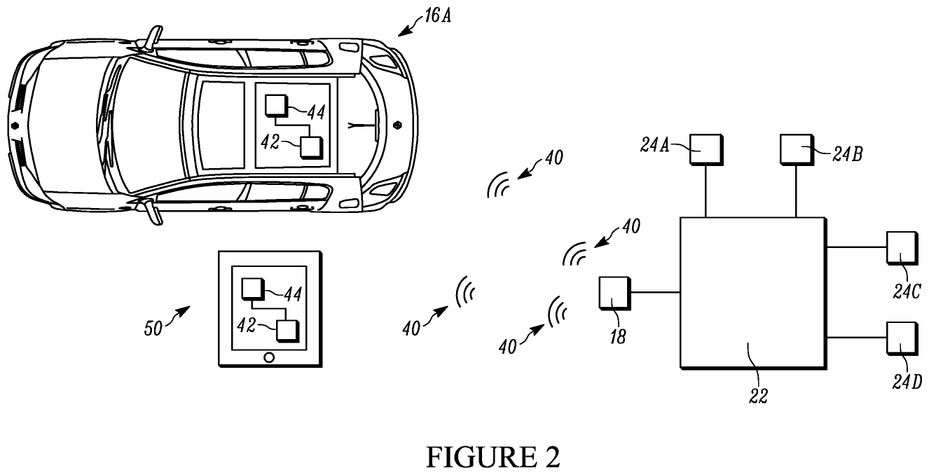

The vehicle 10A is equipped with an erratic driver notification system, shown generally in FIG. 2 at 20. The system 20 includes a control unit in electrical communication with one or more detection devices 24A,24B,24C,24D. The control unit 22 is also in electrical communication with at least one communication device 18. The communication device 18 is enabled with dedicated short range communication (DSRC) for transmitting information regarding the coordinates and operation conditions and parameters of the vehicle 10A. However, it is within the scope of the invention that the communication device 18 may utilize other types of communication, such as LTE or WiFi. The detection devices 24A,24B,24C,24D may be any type of detection device, including, but not limited to, sensors, laser, cameras, LIDAR (Light Imaging, Detection, and Ranging), LADAR (Laser Imaging, Detection, and Ranging), other types of radar, ultrasound, sonar, a global positioning system (GPS), or any other type of suitable detection device.

Each detection device 24A,24B,24C,24D is used to generate the position, i.e., coordinates, of the vehicle 10A relative to the other vehicles 16A,16B,16C,16D,16E during travel on the road 12. The coordinates of the vehicle 10A may include, but are not limited to, pitch angle, roll angle, yaw angle, yaw displacement, and yaw rate. For instance, the detection devices 24A,24B,24C,24D are able to generate data regarding the roll angle 26 of the vehicle 10A, which is the angle of the vehicle 10A about the longitudinal axis 26A (position x). The detection devices 24A,24B,24C,24D are also able to generate data regarding the pitch angle 28 of the vehicle 10A, which is the angle of the vehicle 10A about the lateral axis 28A (position y). The detection devices 24A,24B,24C,24D are able to generate data regarding the yaw angle 30 of the vehicle 10A, which is the position of the vehicle 10A about the yaw axis 30A (position z). Furthermore, the detection devices 24A,24B,24C,24D are also able to detect and generate data regarding the coordinates of the vehicle 10A in the longitudinal direction indicated by arrow 34 (i.e., along the longitudinal axis 26A), the lateral direction indicated by arrow 36 (i.e., along the lateral axis 28A), and in the vertical direction indicated by arrow 38 (i.e., along the yaw axis 30A).

In addition to the coordinates of the vehicle 10A, the detection devices 24A,24B,24C,24D may also detect other operational parameters, including, but not limited to, speed, acceleration, wheel speed, and front wheel angle. The various data generated by the detection devices 24A,24B,24C,24D is also used to determine the vehicle trajectory, indicated by the arrow 32 in the example shown in FIG. 1.

The detection devices 24A,24B,24C,24D may also be used to provide information regarding any input from the driver of the vehicle 10A, such as throttle position, or the amount of brake force applied.

Each of the other vehicles 16A,16B,16C,16D,16E has an x-position and y-position relative to the vehicle 10A, where the x-position and y-position are based on the same coordinate system as the movement in the lateral direction, longitudinal direction, vertical direction, and the roll angle 26, pitch angle 28, and the yaw angle 30.

During travel, when the vehicle 10A is travelling along the road 12, and has the vehicle trajectory 32, which is similar to the other vehicles 16A,16B,16C,16D,16E. However, there may be instances where the vehicle 10A may begin moving in an irregular manner, or performing an undesirable driving maneuver, which may be the result of the driver of the vehicle 10A being distracted (i.e., looking at a cell phone), the driver of the vehicle 10A being under the influence of a chemical substance, the driver of the vehicle 10A having a medical condition which affects coordination and motor skills, or otherwise incapacitates the driver, or any other type situation that may limit the driver from properly operating the vehicle 10A. The movement of the vehicle 10 in an irregular manner may present a danger of one or more of the other vehicles 16A,16B,16C,16D,16E. The system 20 of the present invention is able to provide communication to the other vehicles 16A,16B,16C,16D,16E such that the drivers of the other vehicles 16A,16B,16C,16D,16E may take necessary steps to avoid any dangers as a result of the vehicle 10A performing one or more undesirable driving maneuvers.

Referring again to the example shown in FIG. 1, if the vehicle 10A begins to perform one or more undesirable driving maneuvers, the coordinates of the vehicle 10A resulting from each undesirable driving maneuver is detected by one or more of the detection devices 24A,24B,24C,24D, and information about each undesirable driving maneuver is communicated to the control unit 22. The control unit 22 then commands the communication device 18 to send a signal to the other vehicles 16A,16B,16C,16D,16E, which also have a communication device, such that the drivers of the other vehicles 16A,16B,16C,16D,16E may take the necessary steps to avoid any dangers resulting from the undesirable driving maneuvers of the vehicle 10A.

An undesirable driving maneuver may include one or more different vehicle movements, such as an undesirable acceleration or deceleration (resulting in an undesirable pitch angle 28), an aggressive lane change or an aggressive steering maneuver (resulting in an undesirable roll angle 26, an undesirable yaw angle 30, or both), or any other type of driving maneuver which may result in a danger to the other vehicles 16A,16B,16C,16D,16E. Additionally, there may be different thresholds for each of the lateral acceleration, longitudinal direction acceleration, vertical direction acceleration, the roll angle 26, pitch angle 28, and yaw angle 30, which may be different for various driving situations. For example, in FIG. 1 the vehicle 10A is moving along according to the trajectory 32, where the trajectory 32 of the vehicle 10A is of approximately the same speed and direction as the other vehicles 16A,16B,16C,16D,16E. However, if there is a situation where the driver of the vehicle 10A were to rotate the steering wheel such that the vehicle 10A drifts to the right, this could present a danger, depending upon the degree of rotation of the steering wheel. A minor rotation of the steering wheel would result in a minor change in the steering angle of the front wheels of the vehicle 10A, which would result in the vehicle 10A having the trajectory 32A. This type of trajectory would be suitable for a lane change. However, a significant rotation of the steering wheel would result in a significant change in the steering angle of the front wheels of the vehicle 10A, and would result in the vehicle 10A having the trajectory 32B. This aggressive change in direction may result in an undesirable roll angle 26, undesirable pitch angle 28, undesirable yaw angle 30, a combination of the three, or some other undesirable vehicle characteristic, resulting in a danger to one or more of the other vehicles 16A,16B,16C,16D,16E.

Upon detection of the coordinates of the vehicle 10A which correspond to an undesirable driving manevuer as detected by the detection devices 24A,24B,24C,24D, the control unit 22 then commands the communication device 18 to send a signal, shown generally at 40. Each vehicle 16A,16B,16C,16D,16E includes a corresponding communication device 42 which is able to receive the signal 40, and the communication device 42 is in electrical communication with a notification device, or warning device 44. Upon receiving the signal 40 from the communication device 18, the communication device 42 then commands the warning device 44 to produce some type of warning to the driver of each vehicle 16A,16B,16C,16D,16E that the vehicle 10A is performing one or more unsafe driving maneuvers. The drivers of the other vehicles 16A,16B,16C,16D,16E may take necessary steps to avoid the vehicle 10A, including, but not limited to, slowing down, accelerating, changing lanes, pulling off onto the side of the road 12, or exiting the road 12 completely.

The warning device 44 may be capable to send out different types of alert signals, such as, but not limited to, an audible sound warning, a visual warning, or a haptic warning, to alert the driver of each of the other vehicles 16A,16B,16C,16D that there is a potential danger due to the undesirable driving maneuvers of the vehicle 10A.

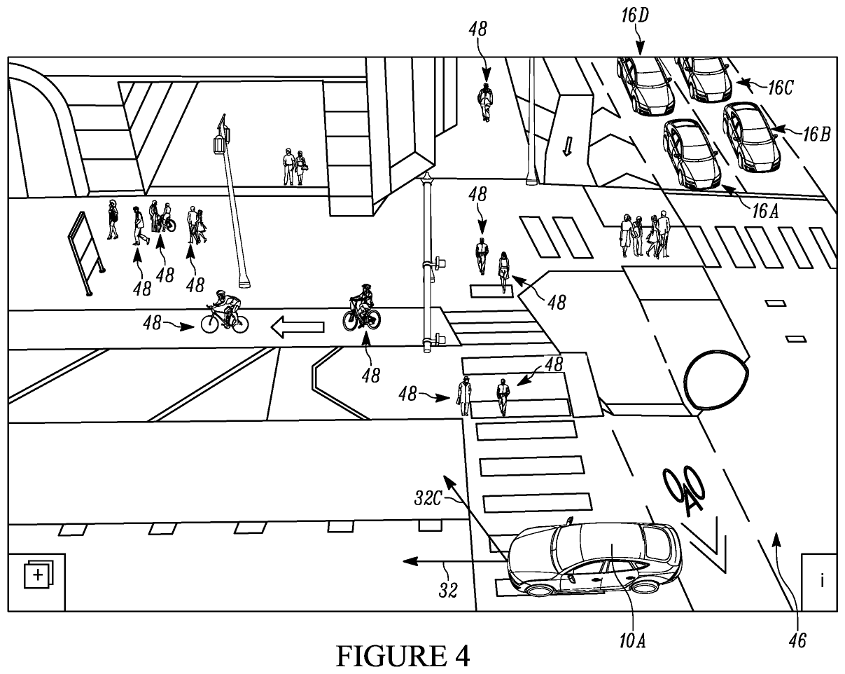

Another example of a notification system 20 is shown in FIG. 4, with like numbers referring to like elements. In this embodiment, the vehicle 10A is passing through an intersection, shown generally at 46. In this example, four of the other vehicles 16A,16B,16C,16D are shown stopped at the intersection 46, and are oriented in a direction substantially perpendicular to the direction of travel of the vehicle 10A. There are also several vulnerable road users (VRU) 48 walking in proximity to the intersection 46.

In this example, some of the VRU's 48 are attempting to cross the intersection, others are walking along side of the intersection on the sidewalk, and others are traveling via bike on a bike lane. The VRU's 48 may be travelling in any number of ways, such as walking, traveling by bicycle, scooter, skateboard, rollerblades, or the like.

In this embodiment of the notification system 20 includes providing a warning to one or more VRUs 48 of the vehicle 10A performing one or more undesirable driving maneuvers.

Once the detection devices 24A,24B,24C,24D determine coordinates of the vehicle 10A, and a determination is made that the vehicle 10 is performing one or more undesirable driving maneuvers and therefore has exceeded one or more acceptable thresholds for lateral acceleration and longitudinal acceleration, the control unit 22 is able to process the information about the vehicle 10A and each undesirable driving maneuver, and determine if the current trajectory 32 of the vehicle 10A presents a danger to one or more of the vehicles 16A,16B,16C,16D or one or more of the VRUs 48. As previously mentioned, a significant rotation of the steering wheel would result in a significant change in the steering angle of the front wheels of the vehicle 10A. In the example shown in FIG. 4, a significant change in the steering wheel angle and would result in the vehicle 10A having the trajectory 32C. This change in direction may result in an undesirable roll angle 26, undesirable pitch angle 28, undesirable yaw angle 30, a combination of the three, or some other undesirable vehicle operation characteristic, resulting in a danger to one or more of the other vehicles 16A,16B,16C,16D,16E or the VURs 48.

If it is determined by the control unit 22 that the vehicle 10A is performing one or more undesirable driving maneuvers, the control unit 22 commands the communication device 18 send a signal to the corresponding communication device 42, which in this example may be part of one of the vehicles 16A,16B,16C,16D,16E, or the communication device 42 and warning device 44 may be part of a personal device or mobile device owned by a VRU 48, such as a cell phone 50. As in the previous example, the warning device 44 may be capable of sending out different types of alert signals, such as, but not limited to, an audible sound warning, a visual warning, or a haptic warning, to alert each VRU 48 that there is a potential danger due to the undesirable driving maneuvers of the vehicle 10A.

As mentioned in the examples described above, which is also applicable to any other driving scenario, there are various acceptable thresholds for lateral and longitudinal acceleration. One example of a threshold for maximum lateral acceleration is less than or equal to 1.80 m/s², and an example of a threshold for maximum longitudinal acceleration is less than or equal to 1.14 m/s². However, it is within the scope of the invention that other thresholds may be used.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. An apparatus, comprising:
an erratic driver notification system, comprising:
a plurality of detection devices being part of a vehicle and for detecting a plurality of coordinates of the vehicle;
a control unit being part of the vehicle, the control unit in electrical communication with the plurality of detection devices;
at least one communication device being part of the vehicle, the at least one communication device in electrical communication with the control unit;
at least one nearby vehicle;
wherein the plurality of detection devices detect when the vehicle is performing at least one undesirable driving maneuver based on the plurality of coordinates of the vehicle, and transfer information regarding the at least one undesirable driving maneuver to the at least one communication device, and the at least one communication device is able to communicate to the at least one nearby vehicle that the vehicle is performing the at least one undesirable driving maneuver.

2. The apparatus of claim 1, the at least one nearby vehicle further comprising:
a second communication device in communication with the at least one communication device; and
a notification device in electrical communication with the second communication device;
wherein the second communication device commands the notification to alert the driver of the at least one nearby vehicle that the vehicle is performing the at least one undesirable driving maneuver.

3. The apparatus of claim 1, the position of the vehicle further comprising at least one coordinate, wherein the at least one coordinate is detected by at least one of the plurality of detection devices.

4. The apparatus of claim 3, the at least one coordinate further comprising at least one of pitch angle, roll angle, yaw angle, yaw displacement, and yaw rate.

5. The apparatus of claim 3, the at least one coordinate further comprising lateral direction, longitudinal direction, and vertical direction.

6. The apparatus of claim 1, the plurality of detection devices operable for detecting at least one of speed of the vehicle, acceleration of the vehicle, wheel speed of the vehicle, and front wheel angle of the vehicle.

7. The apparatus of claim 1, further comprising:
at least one vulnerable road user; and
a personal device in communication with the at least one communication device, the at least one vulnerable road user being in possession of the personal device;
wherein the at least one communication device transfers information regarding the at least one undesirable driving maneuver to the personal device, and the personal device alerts the at least one vulnerable road user that the vehicle is performing the at least one undesirable driving maneuver.

8. An erratic driver notification system, comprising:
a plurality of detection devices being part of a vehicle and for detecting the position of the vehicle;
a control unit being part of the vehicle, the control unit in electrical communication with the plurality of detection devices;
a first communication device being part of the vehicle, the first communication device in electrical communication with the control unit; and
a second communication device in wireless communication with the first communication device; and
a notification device in electrical communication with the second communication device;
wherein the plurality of detection devices detect when the vehicle is performing at least one undesirable driving maneuver, and transfer information regarding the at least one undesirable driving maneuver to the first communication device, and the first communication device transmits a signal to the second communication device such that the second communication device commands the notification device to generate a warning indicating that the vehicle is performing the at least one undesirable autonomous driving maneuver.

9. The erratic driver notification system of claim 8, further comprising:
at least one nearby vehicle, the second communication device and the notification device being part of the at least one nearby vehicle;
wherein the second communication device commands the notification device to alert the driver of the at least one nearby vehicle that the vehicle is performing the at least one undesirable driving maneuver.

10. The erratic driver notification system of claim 8, the position of the vehicle further comprising at least one coordinate, wherein the at least one coordinate is detected by at least one of the plurality of detection devices.

11. The erratic driver notification system of claim 10, the at least one coordinate further comprising at least one of pitch angle, roll angle, yaw angle, yaw displacement, and yaw rate.

12. The erratic driver notification system of claim 10, the at least one coordinate further comprising lateral direction, longitudinal direction, and vertical direction.

13. The erratic driver notification system of claim 8, the plurality of detection devices operable for detecting at least one of speed of the vehicle, acceleration of the vehicle, wheel speed of the vehicle, and front wheel angle of the vehicle.

14. The erratic driver notification system of claim 8, further comprising:
at least one vulnerable road user; and
a personal device, the second communication device and the notification device being part of the personal device, the at least one vulnerable road user being in possession of the personal device;
wherein the at least one communication device transfers information regarding the at least one undesirable driving maneuver to the personal device, and the notification device alerts the at least one vulnerable road user that the vehicle is performing the at least one undesirable driving maneuver.
